(19) United States
(12) Patent Application Publication
(10) Pub. No.: US 2007/0270094 A1
(43) Pub. Date: Nov. 22, 2007

(54) Film valve assembly for a heating, ventilation, and air conditioning system

(76) Inventor: Chun-Shung Liang, Tainan Hsien (TW)

Correspondence Address: OSTROLENK FABER GERB & SOFFEN, 1180 AVENUE OF THE AMERICAS, NEW YORK, NY, 100368403, US

(21) Appl. No.: 11/437,150

(22) Filed: May 19, 2006

(51) Int. Cl. B60S 1/54

(52) U.S. Cl. 454/126

(57) ABSTRACT

A film valve assembly for a heating, ventilation, and air conditioning system includes first and second rollers disposed rotatably on a frame, a film valve, and a driving mechanism. The driving mechanism includes a driving member, and a speed reduction gear unit disposed between the driving member and the first roller. The driving member is operable so as to activate the speed reduction gear unit, thereby rotating the first roller on the frame in a selected one of opposite first and second directions. The second roller is biased to rotate in the first direction. The film valve has two ends coupled respectively to the first and second rollers.

### BACKGROUND OF THE INVENTION

1. Field of the Invention

This invention relates to a film valve assembly, and more particularly to a film valve assembly for a heating, ventilation, and air conditioning system.

2. Description of the Related Art

U.S. Pat. No. 6,616,060 discloses a film valve assembly for a heating, ventilation, and air conditioning system, which includes first and second rollers biased by first and second biasing devices to rotate in opposite first and second directions, respectively. A film valve has two ends coupled respectively to the first and second rollers, and is movable on a frame by rotation of the first and second rollers for controlling flow of air through air apertures in the frame. A drawback of the film valve assembly is that the biasing action of both the first and second biasing devices results in difficulties when the film valve is assembled to the first and second rollers.

### SUMMARY OF THE INVENTION

The object of this invention is to provide a film valve assembly for a heating, ventilation, and air conditioning system that includes a film valve, which can be easily assembled to two rollers.

According to this invention, a film valve assembly for a heating, ventilation, and air conditioning system includes first and second rollers disposed rotatably on a frame, a film valve, and a driving mechanism. The driving mechanism includes a driving member, and a speed reduction gear unit disposed between the driving member and the first roller. The driving member is operable so as to activate the speed reduction gear unit, thereby rotating the first roller on the frame in a selected one of opposite first and second directions. The second roller is biased to rotate in the first direction. The film valve has two ends coupled respectively to the first and second rollers.

Since only the second roller is biased to rotate, and since the first roller is driven by the speed reduction gear unit, the film valve can be easily assembled to the first and second rollers.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is an assembled perspective view of the first preferred embodiment of a film valve assembly for a heating, ventilation, and air conditioning system according to this invention;

FIG. 2 is an assembled perspective view of the first preferred embodiment, illustrating first and second rollers, and two idle rollers;

FIG. 3 is a partly exploded perspective view of the first preferred embodiment, illustrating a driving mechanism;

FIG. 4 is a partly exploded perspective view of the first roller and the driving mechanism of the preferred embodiment;

FIG. 5 is an assembled perspective view of the first preferred embodiment, illustrating an adjustment to relative positioning between the first and second rollers;

FIG. 6 is an assembled perspective view of the second preferred embodiment of a film valve assembly for a heating, ventilation, and air conditioning system according to this invention, illustrating a modified cover; and

FIG. 7 is an assembled perspective view of the third preferred embodiment of a film valve assembly for a heating, ventilation, and air conditioning system according to this invention, illustrating another modified cover.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

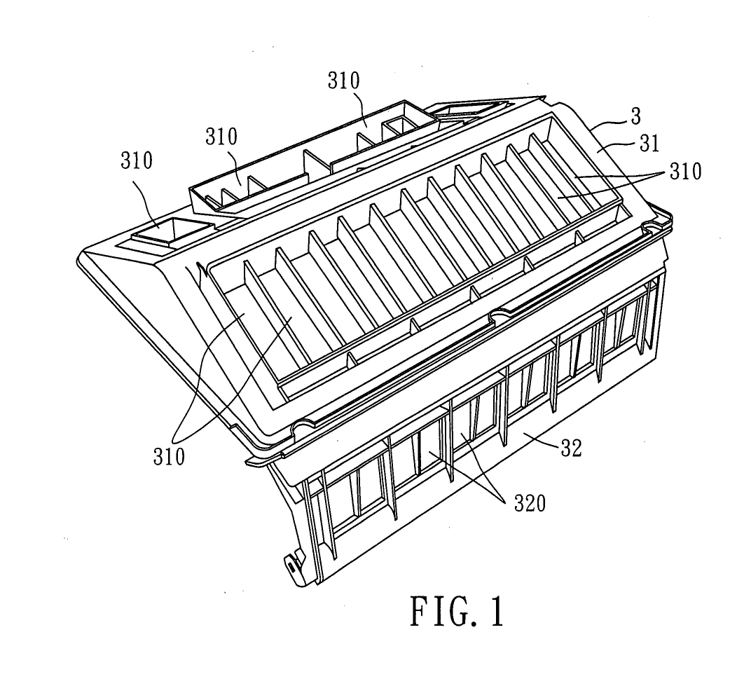

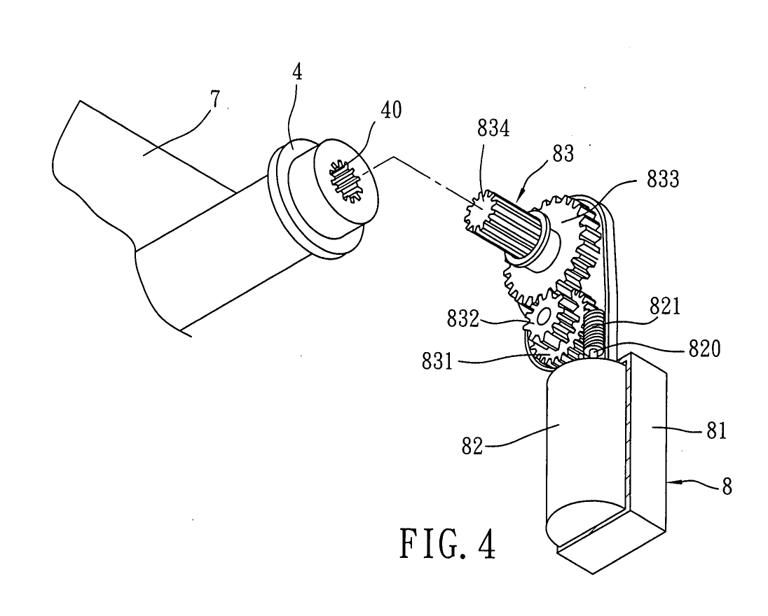

Referring to FIGS. 1 to 4, the first preferred embodiment of a film valve assembly for a heating, ventilation, and air conditioning system according to this invention includes a frame 3, a first roller 4, a tension unit consisting of two idle rollers 5, a second roller 6, a film valve 7, and a driving mechanism 8.

The frame 3 has a generally V-shaped cover 31 and a swing plate 32 having a pivot side 321 connected pivotally to a left side 311 of the cover 31. The cover 31 is formed with a plurality of apertures 310 in a known manner. The swing plate 32 is also formed with a plurality of apertures 320.

The first roller 4 is disposed rotatably on a free side 322 of the swing plate 32, and has an end portion formed with a splined hole 40.

The idle rollers 5 are disposed rotatably on the frame 3 between the first and second rollers 4, 6.

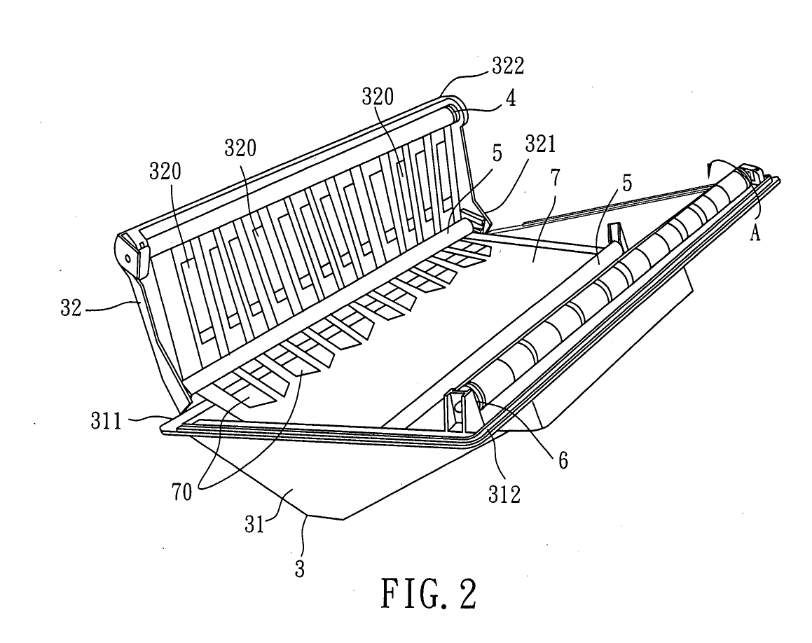

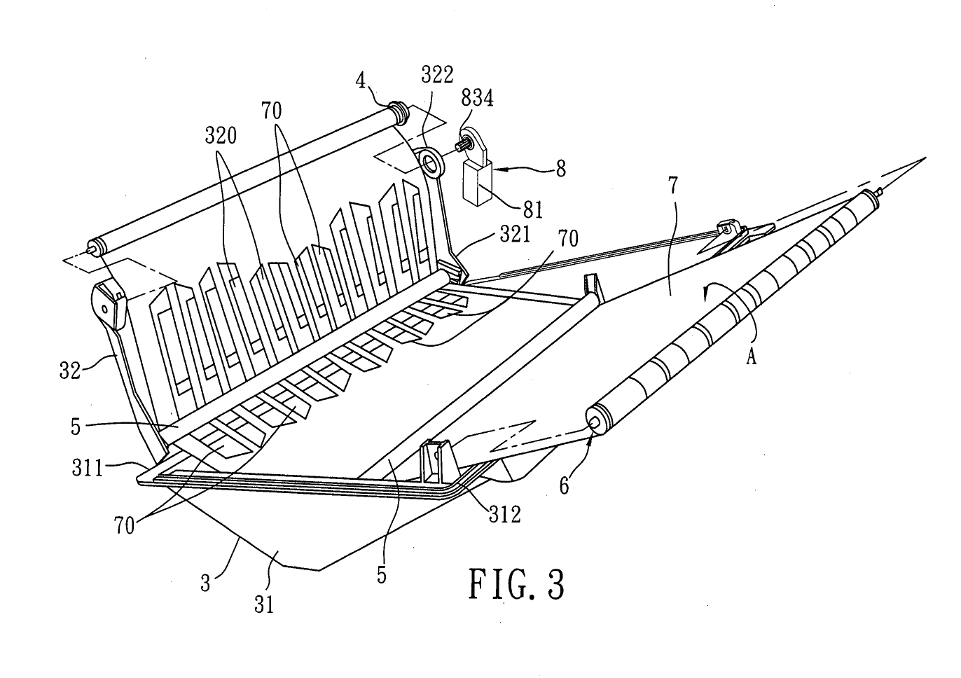

The second roller 6 is disposed rotatably on a right side 312 of the cover 31 of the frame 3 in a known manner, and is biased to rotate in a first direction (A) (see FIGS. 2 and 3) by a torsion spring (not shown).

The film valve 7 is made of a flexible, gas-impermeable material, and has two ends coupled respectively to the first and second rollers 4, 6 in a known manner, and a plurality of apertures 70. The idle rollers 5 support the film valve 7, and aid in maintaining the film valve 7 in a state of tension.

The driving mechanism 8 includes a housing 81 disposed fixedly on the swing plate 32, a driving member 82 configured as a motor, and a speed reduction gear unit 83 disposed between the driving member 82 and the first roller 4. The driving member 82 is operable so as to activate the speed reduction gear unit 83, thereby rotating the first roller 4 on the frame 3 in a selected one of the first direction (A) and a second direction opposite to the first direction. As such, the apertures 70 in the film valve 7 can be moved to completely engage, partially engage, or separate from the apertures 310, 320 in the frame 3 for air flow control of the air conditioning system.

The speed reduction gear unit 83 includes a first gear 831 driven by the driving member 82, a second gear 832 connected fixedly to the first gear 831, a third gear 833, and an externally splined inert rod 834. The driving member 82 includes a motor shaft 820 and a worm shaft 821 connected fixedly to the motor shaft 820. The first gear 831 is configured as a worm wheel, and meshes with the worm shaft 821. The second gear 832 has a diameter smaller than that of the first gear 831. The third gear 833 meshes with the second gear 832, and has a diameter greater than that of the second gear 832. The insert rod 834 is connected fixedly and coaxially to the third gear 833 at one end, and engages the splined hole 40 in the first roller 4 at the other end so as to co-rotate with the first roller 4.

During assembly, since one biasing device of the above-mentioned prior art is omitted and, instead, the speed reduction gear unit 83 is provided for controlling rotation of the first roller 4, the film valve 7 can be easily assembled to the first and second rollers 4, 6.

Therefore, the object of this invention can be achieved.

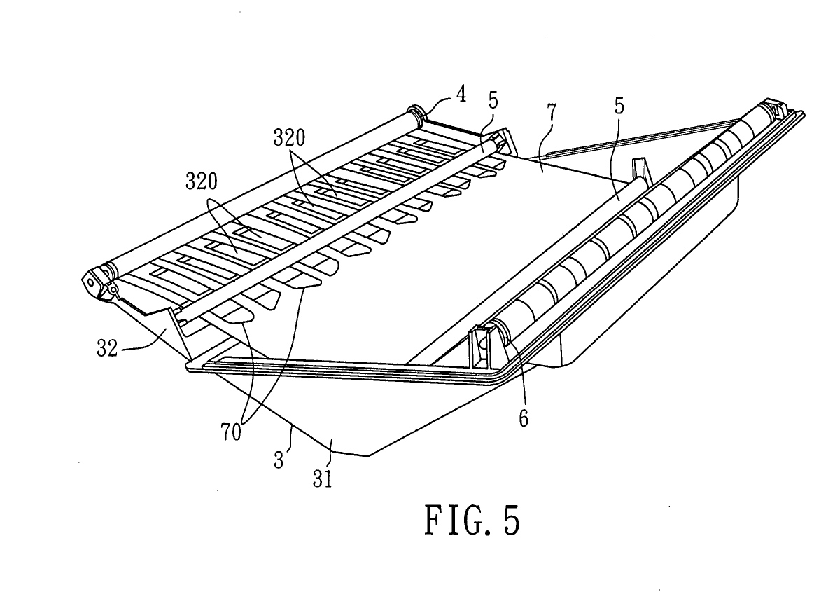

Referring to FIG. 5, to use in another type of air conditioning system, the swing plate 32 can be pivoted relative to the cover 31. This changes the relative positioning between the first and second rollers 4, 6.

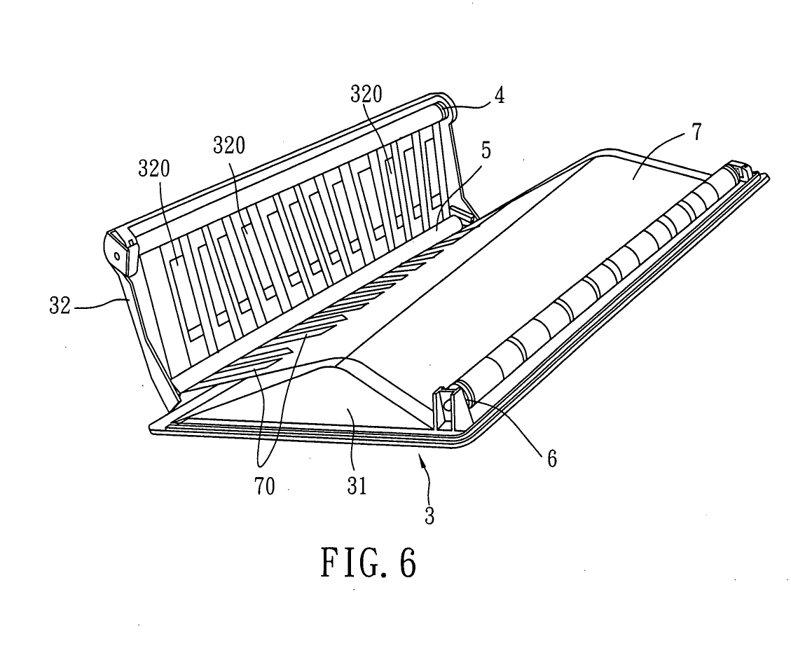

FIG. 6 illustrates a modified cover 31, which is inverted V-shaped.

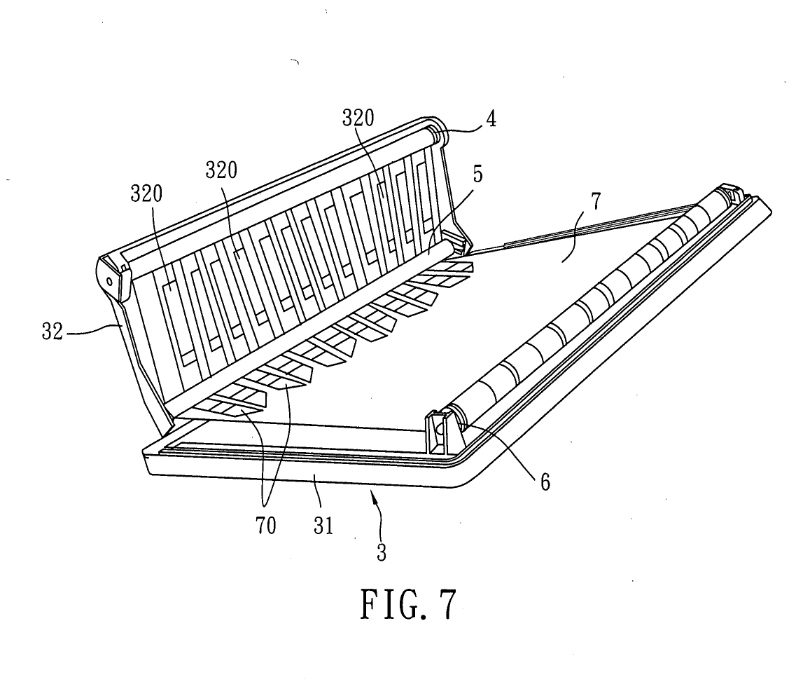

FIG. 7 illustrates another modified cover 31, which is flat.

With this invention thus explained, it is apparent that numerous modifications and variations can be made without departing from the scope and spirit of this invention. It is therefore intended that this invention be limited only as indicated by the appended claims.

I claim:

1. A film valve assembly for a heating, ventilation, and air conditioning system comprising:
a frame;
a first roller disposed rotatably on said frame;
a driving mechanism including a driving member, and a speed reduction gear unit disposed between said driving member and said first roller, said driving member being operable so as to activate said speed reduction gear unit, thereby rotating said first roller on said frame in a selected one of opposite first and second directions;
a second roller disposed rotatably on said frame and biased to rotate in said first direction;
a film valve having two ends coupled respectively to said first and second rollers; and
a tension unit including
at least one idle roller disposed between said first and second rollers for supporting said film valve and aiding in maintaining said film valve in a state of tension.

2. The assembly as claimed in claim 1, wherein said speed reduction gear unit includes:
a first gear driven by said driving member;
a second gear connected fixedly to said first gear and having a diameter smaller than that of said first gear; and
a third gear meshing with said second gear and connected to said first roller such that said first roller is co-rotatable with said third gear, said third gear having a diameter greater than that of said second gear.

3. The assembly as claimed in claim 2, wherein said driving member is configured as a motor, and includes a motor shaft and a worm shaft connected fixedly to said motor shaft, said first gear being configured as a worm wheel and meshing with said worm shaft.

4. The assembly as claimed in claim 2, wherein said first roller has an end portion formed with a splined hole, and said speed reduction gear unit further includes an externally splined insert rod connected fixedly and coaxially to said third gear at one end, and engaging said splined hole in said first roller at the other end so as to co-rotate with said first roller.
